(19) United States
(12) Patent Application Publication
(10) Pub. No.: US 2012/0240751 A1
(43) Pub. Date: Sep. 27, 2012

(54) HYBRID STRINGED INSTRUMENT

(76) Inventor: Ayako Yonetani, Orlando, FL (US)

(21) Appl. No.: 13/427,284

(22) Filed: Mar. 22, 2012

Related U.S. Application Data
(60) Provisional application No. 61/466,815, filed on Mar. 23, 2011.

(51) Int. Cl. G10H 3/18

(52) U.S. Cl. 84/726

(57) ABSTRACT

Herein disclosed is a hybrid stringed instrument. The instrument may have at least one body, at least one string disposed on at least part of the instrument, at least one sensor effective to sense at least one motion of at least one string or the motion caused on another member by operating the at least one string, and at least one neck having at least one electronic interface effective to sense at least one user input or a lack thereof. Further disclosed are methods and programs for creating, receiving, analyzing, sending and converting signals associated with at least some embodiments of a hybrid stringed instrument.

### FIELD OF THE INVENTION

The invention relates to a hybrid stringed instrument. In particular, the invention relates to a stringed instrument that also incorporates electronics.

### SUMMARY

In an exemplary embodiment a hybrid stringed instrument is disclosed. The hybrid stringed instrument may have at least one body, at least one string disposed on at least part of the instrument, at least one sensor effective to sense at least one motion of at least one string or the motion caused on another member by operating the at least one string, and at least one neck having at least one electronic interface effective to sense at least one user input or a lack thereof.

In another exemplary embodiment a hybrid stringed instrument is disclosed, including: at least one string attached on at least two points of the hybrid stringed instrument; a bridge disposed on the hybrid stringed instrument and in contact with the at least one string; at least one sensor disposed on the hybrid stringed instrument effective to sense at least one motion; at least one neck including at least one electronic interface effective to sense at least one user input or lack thereof, and; a computer effective to process a first input or lack thereof from the at least one sensor and a second input or lack thereof from the at least one electronic interface, and effective to output at least one output signal, the at least one output signal convertible into at least one sound.

In yet another exemplary embodiment a hybrid stringed instrument system is disclosed. The hybrid stringed instrument system including: at least one string attached on at least two points of the hybrid stringed instrument system; a bridge disposed on the hybrid stringed instrument and in contact with the at least one string; at least one bow; at least one neck including at least one electronic interface effective to sense at least one user input or lack thereof; at least one sensor disposed on at least one member selected from the group consisting of the at least one bow, the at least one hybrid stringed instrument, the at least one neck, and the at least one electronic interface, and effective to sense at least one motion; and at least one computer effective to process a first input from the at least one sensor and a second input from the at least one electronic interface, and effective to output at least one output signal, the at least one output signal convertible into at least one sound.

Further disclosed is a method which may include the steps of: effecting at least one motion; converting the at least one motion into a first input signal using a sensor effective to detect the at least one motion, wherein the sensor is disposed in a hybrid stringed instrument comprising at least one string attached to at least one body, and at least one neck comprising at least one electronic interface, and at least one computer effective to process a first input signal from the at least one sensor and a second input signal or lack thereof from the at least one electronic interface, the computer effective to create at least one output signal, the at least one output signal convertible into at least one sound; sensing the electronic interface for the at least one user input, the electronic interface outputting the second input signal corresponding to the at least one user input or lack thereof; receiving the first input signal and the second input signal using the at least one computer; and creating the output signal based on the first input signal and the second input signal using a program module and at least one stored signal.

Also disclosed is a method of training to produce a desired output on a stringed instrument, including: associating a location on a hybrid stringed instrument for an expected user input effective to produce the desired output, wherein a shape of the hybrid stringed instrument corresponds to a shape of the stringed instrument, and wherein the location on the hybrid stringed instrument corresponds to a location on the stringed instrument that produces the desired output; associating a time for the expected user input with a time for the desired output; and indicating the location on the hybrid stringed instrument where the user input is expected proximate a time when the user input is expected to produce the desired output.

Another embodiment disclosed includes a method of training to produce a desired output on a stringed instrument, including: applying a user input on a hybrid stringed instrument effective to produce a desired output, wherein the hybrid stringed instrument comprises a sensor effective to sense the applied user input from a variety of possible user inputs; and observing the hybrid stringed instrument for feedback regarding an accuracy of the applied user input.

### BRIEF DESCRIPTION OF THE DRAWINGS

The invention is explained in the following description in view of the drawings that show:

FIG. 1A is a face view of an embodiment of a hybrid stringed instrument.

FIG. 1B is a side view of the hybrid stringed instrument of FIG. 1.

FIG. 2 is a perspective view of an embodiment of a bow.

FIG. 3 is a flowchart of the method of the invention.

FIG. 4 is a view of an embodiment of an electronic interface.

FIG. 5 is a flowchart of an alternate exemplary embodiment of the invention.

FIG. 6 is a flowchart of another alternate exemplary embodiment of the invention.

### DETAILED DESCRIPTION

Disclosed embodiments in this Disclosure are described with reference to the attached figures, wherein like reference numerals are used throughout the figures to designate similar or equivalent elements. The figures are not drawn to scale and they are provided merely to illustrate the disclosed embodiments. Several aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring structures or operations that are not well-known. This Disclosure is not limited by the illustrated ordering of acts or events, as some acts may occur in different orders and/or concurrently with other acts or events. Furthermore, not all illustrated acts or events are required to implement a methodology in accordance with this Disclosure.

Notwithstanding that the numerical ranges and parameters setting forth the broad scope of this Disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

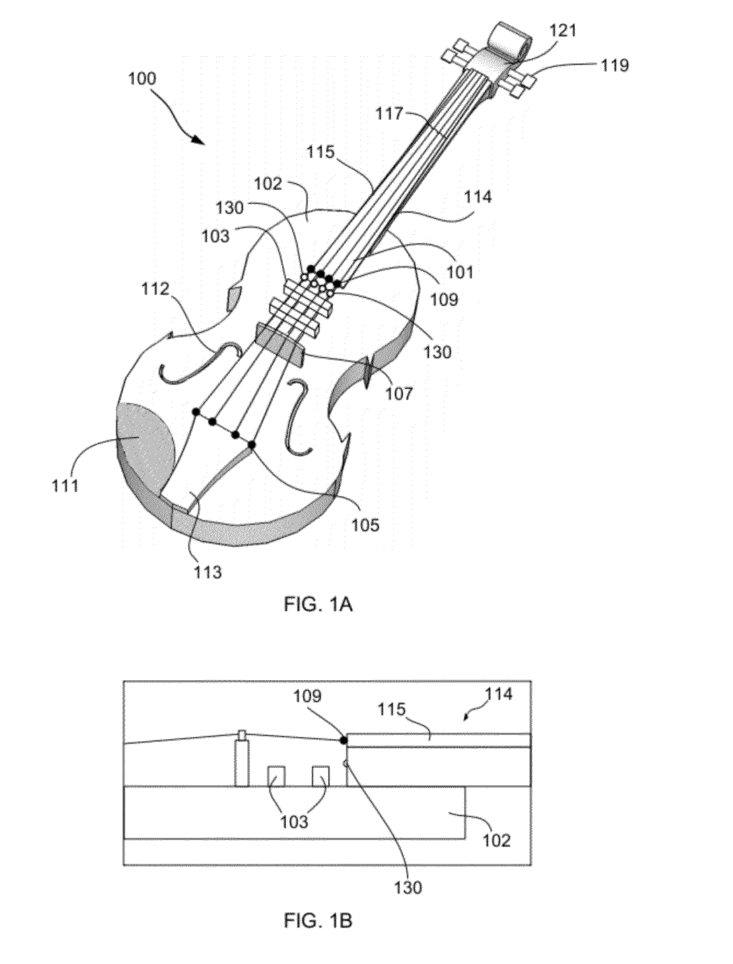

Referring to FIGS. 1A and 1B, an embodiment hybrid stringed instrument 100 is shown. In some embodiments, the instrument has a body 102, a neck 114, and least one string 101 disposed on at least part of the body 102. The body 102 may be made into any shape. In some embodiments, the body 102 may take the shape of any stringed instrument, such as a violin, viola, guitar, cello, mandolin, ukulele, bass guitar, or any other stringed instrument. The embodiment shown in FIG. 1A and FIG. 1B is in the shape of a traditional violin with f-holes 112 cut into the body 102 and a chin rest 111 attached to the body 102.

At least one string 101 may be attached to the body 102. There may be any number of strings to fit the instrument as desired. In some embodiments, where the design of the instrument is meant to mimic a traditional violin, there may be four strings 101.

The at least one string 101 may be made of any material suitable for instrument strings, and may be of any length. The at least one string 101 may be made of a plastic, such as nylon, a metal, such as steel, and combinations thereof. In some embodiment the at least one string 101 is nylon wrapped with a metal. The at least one string 101 may also be a metal wound with another metal such as nickel wrapped steel. For example, the at least one string 101 may be at least a portion of a string used for any stringed instrument, such as violin strings.

The at least one string 101 may be attached to the body at a first point 109. The first point 109 may be at the meeting of the neck 114 and the body 102 as shown in FIG. 1A, or it may be anywhere else on the body 102 or on an extension thereof. The first point 109 may also be anywhere on the neck 114 or an extension thereof. In some embodiments, referring to FIG. 1B, the first point 109 may be located on a raised portion of the neck 114, such as to connect with a side of the neck 114. The first point may be located on an electronic interface 115 that is disposed on said neck 114.

In some embodiments, the at least one string 101 is attached to a second point 105. The second point 105 may be on the body 102, on the neck 114, or on an extension of either the neck 114 or the body 102. For example, as shown in FIG. 1, the second point 105 may be located on the tailpiece 113 which may be attached to the body 102. It is possible to attached the at least one string 101 to more than two points on the body, neck, extensions thereof or any combination thereof.

The length of the at least one string 101 may be defined by where the connection points are located. For example, the closer the connection points, the shorter the at least one string 101 may be. In at least some embodiments, the at least one string 101 does not traverse the entire neck 114. In some embodiments, the at least one string 101 does not traverse any part of the neck 114. The strings may be tightened to emulate at least one characteristic of strings on a traditional instrument, such as the feel of a bow vibrating the strings of a violin.

The hybrid stringed instrument 100 may have a bridge 107 disposed on the body 102. The bridge 107 may be disposed in such a position that when the at least one string 101 is attached, the at least one string 101 contacts the bridge 107. The contact may occur between the first point 109 and the second point 105. The bridge 107 may be disposed integrally upon the body 102 such that it is a part of the body 102, or it may be a separate piece attached to the body 102 through compressive force of the at least on string 101, or through any other method of attachment such as adhesion or latching.

The instrument 100 may have at least one sensor 103 that is effective to sense the motion of the at least one string 101. The at least one sensor 103 may be disposed anywhere within a sensing distance of said at least one string 101. The at least one sensor 103 may be disposed on the body 102 of the instrument 100, on the bridge 107, on the neck 114, at the first point 109, or at the second point 105. The at least one sensor 103 may be any sensor that can detect movement or vibrations and convert such detections into an electrical signal. Non-limiting examples include magnetic pickups (such as used on an electric guitar), acoustic sound devices such as microphones, devices that use light waves such as RF or laser light to detect motion, pressure sensing devices, tension sensing force gauges, gyroscopic devices, accelerometers, and piezo-electric devices.

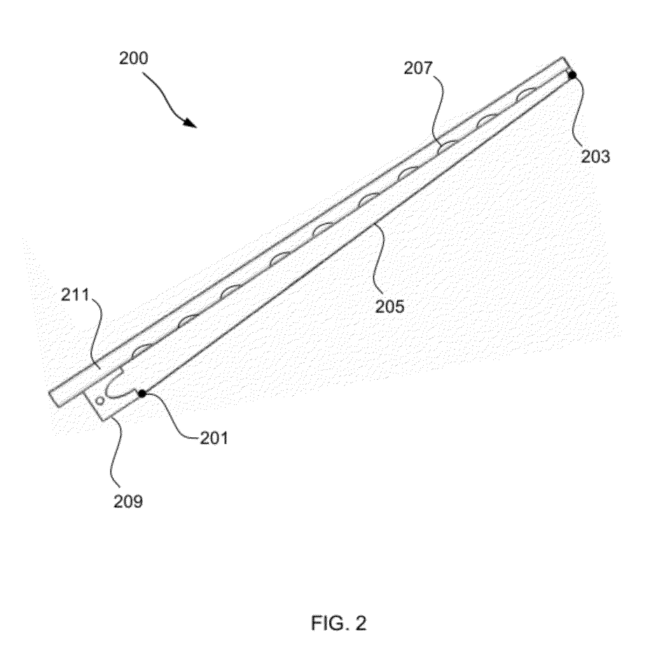

Referring to FIG. 2, in some embodiments, the instrument 100 may comprise at least one bow 200 with at least one bow sensor 207 placed anywhere on the bow 200. The bow 200 may have at least one bow sensor 207 placed on the bow body 211 as shown in FIG. 2, on a first tip 201, a second tip 203, on a contact portion 205, on a handle portion 209 or on any combination thereof. The at least one bow sensor 207 may be used for sensing the vibrations of the at least one string 101 or for sensing the movement and/or vibrations of the bow 200.

The at least one bow sensor 207 may be any sensor that can detect movement or vibrations and convert such detections into an electrical signal. Non-limiting examples include magnetic pickups (such as used on an electric guitar), acoustic sound devices such as microphones, devices that use light waves such as RF or laser light to detect motion, pressure sensing devices, tension sensing force gauges, gyroscopic devices, accelerometers, and piezo-electric devices.

There may or may not be at least one sensor 103 on the instrument 100 if there are sensors on a bow 200. For example, all sensors could be located on the bow 200. In other embodiments, there may be at least one sensor 103 on the instrument 100 to sense the motion of the strings, and there may be at least one bow sensor 207 on the bow 200 to sense the motion and/or vibrations of the bow 200.

Referring back to FIG. 1, in at least some embodiments, at least one electronic interface 115 is present on at least a portion of the neck 112. The electronic interface 115 is effective to sense at least one user input from a variety of possible inputs. The electronic interface 115 may take any shape. For example, the electronic interface 115 may be flat or may have a raised portion to mimic the feel of one or more strings.

In some embodiments, at least a portion of the electronic interface 115 has a touch screen for approximating the position of a user input. The touch screen may be resistive, surface acoustic wave based, capacitive, infrared, optical, any combination thereof, or any other technology used for touch screen devices.

A user input may be characterized by type, and for each type there may be several aspects that may vary from one user input to the next. The placement of fingers on the electronic interface 115 as may be done by a person playing a stringed instrument such as a violin may be one type of user input. In this instance additional characterizing information may include a specific location such that the finger press is distinguished from other possible finger presses. Another type of user input may be exciting a string, such as by moving a bow across the string. In this instance the user input may be characterized by which particular string is being excited and how the string is being excited (for instance, by pulling a bow across, or plucking etc), Both types of user inputs may further be characterized by duration as well as other characteristics. For example, a finger press may be steady, or rock back and forth. A string excitation may be firm or gentle, or continuous or interrupted etc. Thus, a user input may be exciting a string, pressing on the neck, or both, and each may be characterized by information describing multiple aspects of the user input. The user input may also be exciting more than one string simultaneously and/or pressing on the neck at more than one location simultaneously.

The electronic interface 115 may also have a display device. The display device may show information on the electronic interface so that the user may make coordinated inputs. In some embodiments, the display device shows at least one digital string 117. In some embodiments, the display shows the neck board of a violin having four digital strings 117.

The display device may also show musical theory, text, notes, videos, pictures, or any combination thereof. The music theory may be integrated into a video or picture slideshow progressively showing the user where to place fingers in order to play a predetermined series of notes or predetermined songs. For example, the display device may show at least one digital point that lights up where the user should place their fingers on the neck in order to play a desired note or series of notes. At least one digital point may also be displayed anywhere on the electronic interface to signify for the user to not have any finger inputs, but to strum an “open” note. The at least one digital point may be of any shape and any color. In some embodiments, the at least one digital point may also change shape and or color.

A series of digital points may be displayed simultaneously or sequentially. The digital points may be temporary, subject to change, permanently displayed, or any combination thereof. A series of digital points may be displayed an interval before the user is to play a note in order to give time to the user in order to make the correct finger placements. The interval may be any period of time, and may be variable using an interval control. At least one digital point may be displayed after the user operates the neck to show the user where they touched previously. This could be used as an educational mechanism, a visual mechanism, a comparative mechanism to determine accuracy or playing, or any other purpose a display point could be used.

In addition to the electronic interface 115, the instrument 100 may further include an indicator that may provide information regarding the string 101. The indicator may be, for example, a string indicator light 130, or any suitable indicator that may emphasize one string. In an exemplary embodiment the string indicator light 130 may light when the string 101 receives user input or when the instrument 100 expects a user input on the particular string 101. In another exemplary embodiment where there exists a plurality of strings 101 there may be a respective indicator light 130 for each string 101. In operation a respective indicator light 130 may light under or highlight (by for example, shining on) a respective string 101 when the respective string 101 receives a user input. When used in conjunction with the electronic interface 115, the instrument 100 may be operated in a first manner where it simply emulates a corresponding stringed instrument without electronics. In this mode the hybrid stringed instrument may be considered to be operating in a passive mode where it produces output in accord with user input like the regular stringed instrument does.

The hybrid stringed instrument 100 may be operated in a second mode where it takes on an active role. In the second mode, which may be a feedback mode or a training mode, the instrument 100 may provide feedback to a user. For example, the stringed instrument 100 may be pre-programmed with a particular lesson plan, or a song. In this mode the user may, through an input device/interface, select what desired output the user wishes to play. In an exemplary embodiment the hybrid stringed instrument may include a memory configured to store one or more of these desired outputs, and the user may simply select a desired output. At this point the hybrid stringed instrument will recognize user input and determine a relationship between the user input and the desired output. In this manner the hybrid stringed instrument will “know” what the desired output is, and will be able to track actual user input(s) to see if the actual user input(s) correspond to a correct user input(s) needed to achieve the desired output.

In a feedback mode when the user uses the stringed instrument 100 to effect the lesson plan or the song etc the stringed instrument 100 may indicate where the user provides input not in accord with an expected input, i.e. incorrect input. In a feedback or training mode, once a desired output is selected the user must mentally determine what input is needed. Thus, the user must mentally select the user input, and the physically apply that user input to the hybrid stringed instrument 100. One the user applies the user input, the respective string indicator light 130 may indicate the particular string 101 that was to have been excited if user input was not received as expected. Similarly, if the user input expected is a finger press on the neck, the electronic interface 115 may likewise indicate if the user input was not received as expected. Such indication could take any form, including a sound or noise indicating the incorrect user input, a.k.a. the incorrectly “played” noted. Indicating lights as described above could light or flash at the correct location to draw the user's eyes there, or alternately could light or flash at the incorrect location etc. Alternately the correction note may be displayed in a manner that does not physically indicate the correct user input. This would force the user to figure out the correct user input on his or her own. In an exemplary embodiment the hybrid stringed instrument may be programmed to pause until the correct user input is received, or alternately to continue playing without interruption. In this manner the user will receive feedback from the hybrid stringed instrument geared toward improving the user's performance.

In another exemplary embodiment, the stringed instrument 100 may take a yet more active role and provide indication in anticipation of user input. For example, when a desired output such as a lesson plan or song is preprogrammed into the stringed instrument 100, the stringed instrument 100 may indicate where user inputs are expected as the lesson or song progresses. This may happen in real time, reduced speed, increased speed, and/or even slightly ahead of when the user input is actually expected in order to give the user time to apply the user input. For example, the string indicator light 130 and/or the electronic interface 115 may indicate which string is to be excited and/or where on the neck the user is to press at a moment when these inputs are expected or a certain amount of time before. In this way a user may be able to follow the indications and learn how to play the expected lesson and/or song. In these more active modes the stringed instrument 100 may be considered to be acting as a training instrument, such that the stringed instrument 100 trains the user to play the lesson and/or song, and the user is trained by the stringed instrument 100.

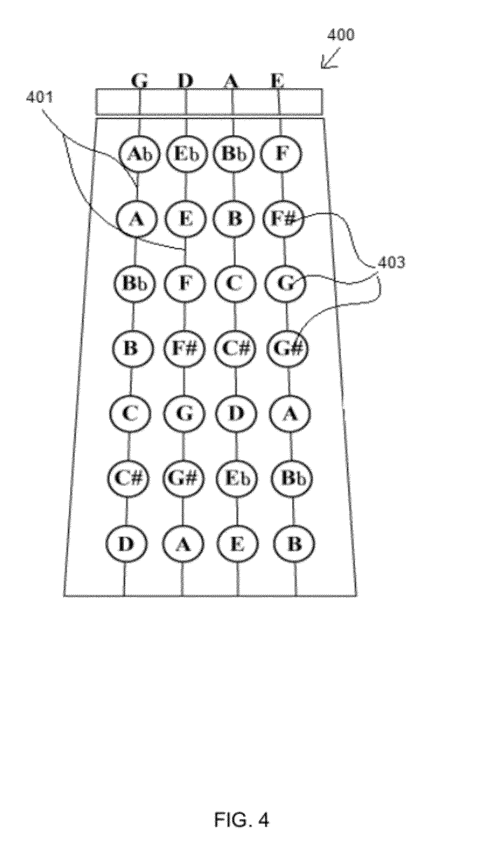

Referring to FIG. 4, the digital display on the electronic interface 400 may display a virtual violin neck with four digital strings 401, and show the user where to place their fingers to effectively play a desired note using at least one digital point 403 as described above and that is displayed on the electronic interface 400. Again, the at least one digital point 403 may be any shape or color, even a letter, symbol, or combination thereof. A series of digital points 403 may be displayed, either simultaneously or sequentially, as a guide for the user to play a desired series of notes, scales, rhythms, songs, the like and any combination thereof.

The electronic interface 115 may output a playback signal which may be converted into sound that corresponds with the video or picture slideshow that is displayed on the electronic interface. The playback signal may be independent of a user input signal on the electronic interface 115, or it may be modified or mixed with a user input signal.

In some embodiments, the playback signal could be independent of what, if anything, is displayed on the display device. For example, the electronic interface 115 may be used as a music playback interface that allows the user to play back at least a portion of a stored sound, such as a song, with or without an image or video being displayed on the display device. This may allow a person who plays live shows to play back music through the instrument 100 while on an intermission. It may also allow a person to play a song from memory on the instrument 100 with the song playing, but without the note being shown on the electronic interface 115.

The instrument 100 may have at least one computer effective to process signals from the at least one sensor and the at least one electronic interface 115. The at least one computer may be effective to output at least one output signal that is convertible into at least one sound by at least one speaker. The computer may be placed on the instrument 100, in the instrument 100, or apart from the instrument 100 and may be connected either wirelessly or via a hard connection.

The computer may also be used to compare the accuracy of the user versus the display points 403. This value may be displayed on the display device at any time.

In some embodiments, a hybrid stringed instrument 100 has a body 102, a neck 114 with an electronic interface 115, at least one string 101, and either at least one sensor 103, at least one bow sensor 207 or both.

In at least some embodiments, if a person does or does not place at least one finger on the at least one digital string 117 and then proceeds to strum, pluck, pick, bow, or otherwise operate the at least one string 101, a predetermined signal may be sent to a converter device to make a predetermined sound.

Removing any user input on the electronic interface 115 may allow for a predetermined open note to be sounded when the at least one string 101 is operated. The open note may be set either completely digitally or by a combination of digital and actual tuners. For example, a head 121 may have tuning keys 119 which could be linked to the instrument 100 in such a way that when the keys are turned, a sensor converts the turning into a signal and an inboard computer reacts in such a way that the “tuning” of the digital string 117 changes by scaling the frequency of the output sound either up or down corresponding to the change. There may also be fine tuners as well placed anywhere on the instrument, such as on the tailpiece 113.

The frequency of the output sound may be modified by changing the position of the finger on the digital string 117. Depending on other input variables such a surface area of finger contact, shape of finger contact, pressure, etc. the tonal characteristics and volume (amplitude) of the output sound may be modified.

The volume of the output may be modified by how powerfully the at least one string 101 is operated. The at least one sensor 103 or the at least one bow sensor 207 or any combination thereof may have the ability to detect tonal and frequency variations including harmonic responses and thus modify the output sound frequency and tone. There may also be volume controls to change the final output of the instrument. In some embodiments, there are tonal controls, such as a tone nob, to modify the final output of the instrument. There may also be effects controls included on the instrument to add different effects such as delay, chorus, reverb, flange, phaser, wah, and any other type of musical effect.

The instrument may also include a speaker. The speaker may be placed on the instrument, inside the instrument, or outside the instrument. The speaker may be effective to convert an output signal to sound.

The instrument may further include an output socket for routing the final output signal to another device or outside speaker, either wirelessly or via a hard connection.

In some embodiments, the output of the electronic interface 115 as related to the position of the user inputs is coordinated to function as a stringed instrument such as a violin. Thus, the closer the contact of the user input on the electronic interface 115 is to the body 102, the higher frequency the output sound may be. This allows a user to play the instrument 100 as if it were a real violin, but without having to apply the force necessary to hold actual violin strings down. Because of the at least one string 101, the user can bow, pluck, pick, or strum the at least one string 101 and maintain the same feel of operation as a real acoustic or electric instrument. If the electronic interface 115 has a raised portion to mimic the touch of actual strings on a traditional neck, the feel may approximate a traditional instrument even closer.

In an embodiment the device may be configured to determine a range and a playability of the particular instrument.

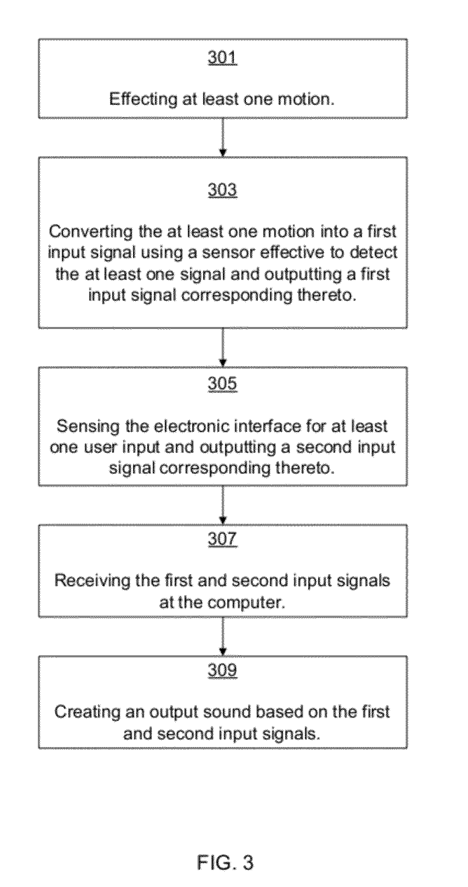

Further disclosed is a method of creating sound. Referring to FIG. 3, the method may include the steps of: effecting at least one motion 301; converting the at least one motion into a first input signal using a sensor effective to detect the at least one signal and outputting a first input signal corresponding thereto 303; sensing the electronic interface for at least one user input and outputting a second input signal corresponding thereto 305; receiving the first and second input signals at the computer 307; and creating an output sound based on the first and second input signals 309.

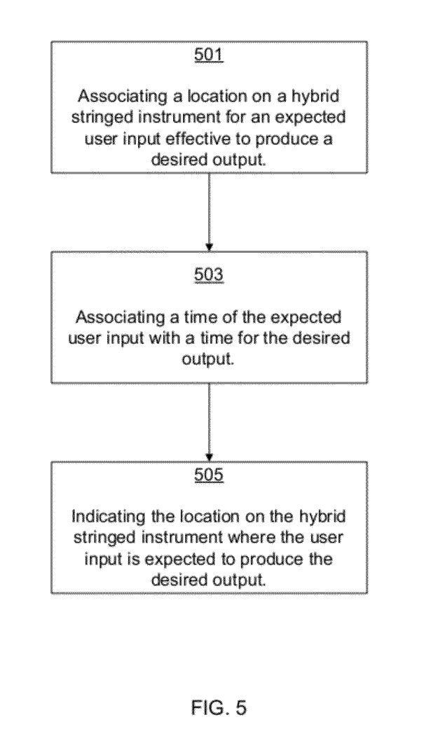

Disclosed in FIG. 5 is a method of training to produce a desired output on a stringed instrument. The method may include the steps of: associating a location on a hybrid stringed instrument for an expected user input effective to produce a desired output 501; associating a time of the expected user input with a time for the desired output 503; and indicating the location on the hybrid stringed instrument where the user input is expected to produce the desired output 505.

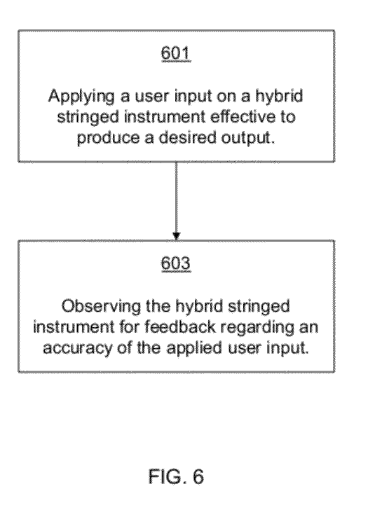

Disclosed in FIG. 6 is another method of training to produce a desired output on a stringed instrument. The method may include the steps of: applying a user input on a hybrid stringed instrument effective to produce a desired output 601, wherein the hybrid stringed instrument comprises a sensor effective to sense the applied user input from a variety of possible user inputs; and observing the hybrid stringed instrument for feedback regarding an accuracy of the applied user input 603.

The computer may have a program module to compare, analyze, or react to the signals and create the output signal based on the characteristics of the two signals as indicated in step 309. For example, the computer may select to output at least one “open” note signal if there is a “no touch” signal (possibly a lack of a signal all together) from the electronic interface and if there is a motion signal from the at least one sensor. The output signal may be selected from a storage database. The output signal may also be a modification of the first input signal, the second input signal, a stored signal, or any combination thereof.

The method may further comprise the step of sending 311 the output signal to an output device using the computer or microprocessor. There may be a program module to send the output signal to at least one output device. The output signal may be sent through a wired connection or through a wireless connection to the at least one output device. The at least one output device may be at least one output speaker that converts the signal into sound. The at least one output device may also be a signal modifier such as an amplifier, an effects modifier, or any other post instrument modification signal modification system. In some embodiments, there may be any number and combination of the at least one output devices as described above.

In at least some embodiments, computer program codes for carrying out methods and/or program modules may be written in an object oriented and/or conventional procedural programming languages including, but not limited to Java, Smalltalk, Perl, Python, Ruby, Lisp, PHP, “C”, FORTRAN, or C₊₊. The program codes may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Certain embodiments are described herein with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer-readable program code modules. These program code modules may be provided to a processing module of a general purpose computer, special purpose computer, embedded processor or other programmable data processing apparatus to produce a machine, such that the program code modules, which execute via the processing module of the computer or other programmable data processing apparatus, create means for implementing the functions specified in the flowchart and/or block diagram block or blocks.

These computer program code modules may also be stored in a computer-readable memory that can direct a computer or other programmable data processing apparatus to function in a particular manner, such that the program code modules stored in the computer-readable memory produce an article of manufacture. The computer program code modules may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

Any cited references are incorporated herein in their entirety to the extent not inconsistent with the teachings herein. While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

Thus, the breadth and scope of the subject matter provided in this Disclosure should not be limited by any of the above explicitly described embodiments. Rather, the scope of this Disclosure should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A hybrid stringed instrument comprising:
at least one body;
at least one string disposed on at least part of said hybrid stringed instrument;
at least one sensor effective to sense at least one motion; and
at least one neck comprising at least one electronic interface effective to sense at least one user input or lack thereof.

2. The hybrid stringed instrument of claim 1, wherein said body is a violin body.

3. The hybrid stringed instrument of claim 1, wherein said at least one neck is a violin neck.

4. The hybrid stringed instrument of claim 1, wherein said at least one string comprises four strings.

5. The hybrid stringed instrument of claim 1, wherein said electronic interface is a touch screen capable of sensing said at least one user input.

6. The hybrid stringed instrument of claim 1, wherein said user input is at least one finger.

7. The hybrid stringed instrument of claim 1, further comprising at least one speaker.

8. The hybrid stringed instrument of claim 1, further comprising an output socket.

9. A hybrid stringed instrument, comprising:
at least one string attached on at least two points of said hybrid stringed instrument;
a bridge disposed on said hybrid stringed instrument and in contact with said at least one string;
at least one sensor disposed on said hybrid stringed instrument effective to sense at least one motion;
at least one neck comprising at least one electronic interface effective to sense at least one user input or lack thereof; and
a computer effective to process a first input from said at least one sensor and a second input or lack thereof from said at least one electronic interface, and effective to output at least one output signal, said at least one output signal convertible into at least one sound.

10. The hybrid stringed instrument of claim 9, further comprising at least one output speaker, said output speaker effective to receive said at least one output signal and convert said output signal into sound.

11. The hybrid stringed instrument of claim 10, wherein said at least one output speaker is disposed on said hybrid stringed instrument.

12. The hybrid stringed instrument of claim 9, wherein said at least one string comprises four strings capable of being bowed.

13. The hybrid stringed instrument of claim 9, wherein said at least one sound imitates an instrument selected from the group consisting of a violin, a viola, a cello, a guitar, a mandolin, a ukulele, a bass guitar, and a violin being played as a fiddle.

14. The hybrid stringed instrument of claim 9, wherein said at least one electronic interface is a touch screen.

15. The hybrid stringed instrument of claim 9, wherein said at least one electronic interface may further comprise at least one display.

16. The hybrid stringed instrument of claim 9, further comprising an output socket.

17. (canceled)

18. (canceled)

19. (canceled)

20. (canceled)

21. A method of training to produce a desired output on a stringed instrument, comprising:
associating a location on a hybrid stringed instrument for an expected user input effective to produce the desired output, wherein a shape of the hybrid stringed instrument corresponds to a shape of the stringed instrument, and wherein the location on the hybrid stringed instrument corresponds to a location on the stringed instrument that produces the desired output;
associating a time for the expected user input with a time for the desired output; and
indicating the location on the hybrid stringed instrument where the user input is expected proximate a time when the user input is expected to produce the desired output.

22. The method of claim 21, wherein the desired output is a note, a lesson plan, or a song.

23. The method of claim 21, wherein the location on the hybrid stringed instrument is on a neck of the hybrid stringed instrument.

24. The method of claim 23, wherein an electronic interface indicates the location on the neck.

25. The method of claim 21, wherein the location on the hybrid stringed instrument is on a string disposed on the hybrid stringed instrument.

26. The method of claim 21, further comprising generating and indication when an actual location of the user input does not correspond to the expected location.

27. (canceled)

28. (canceled)

29. (canceled)

30. (canceled)

31. (canceled)

32. (canceled)
